(19) United States
(12) Patent Application Publication
(10) Pub. No.: US 2004/0243477 A1
(43) Pub. Date: Dec. 2, 2004

(54) System and method for online commerce

(76) Inventors: Thomas J. Mathai, Petaling Jaya (MY); Kenneth Margon, Oakland, CA (US)

Correspondence Address: HUNTON & WILLIAMS LLP, INTELLECTUAL PROPERTY DEPARTMENT, 1900 K STREET, N.W., SUITE 1200, WASHINGTON, DC, 20006-1109, US

(21) Appl. No.: 10/763,415

(22) Filed: Jan. 26, 2004

Related U.S. Application Data
(60) Provisional application No. 60/442,128, filed on Jan. 24, 2003.

(51) Int. Cl. G06F 17/60

(52) U.S. Cl. 705/26

(57) ABSTRACT

The invention provides a secure online payment method and system. In an embodiment of the invention, a transaction system facilitates online purchase of merchant items by customers and to have those purchased items billed, i.e., debited, to a telephone account. Particularly, the system comprises a number of customer web access devices, a TCP/IP communications network, a number of merchant computers, a centralized payment server, and a number of telecommunication company (TELCO) networks. Communications are bridged between the TCP/IP network and the number of TELCO networks implementing, for example a common channel signaling (CCS) based protocol, such as signaling system 7 (SS7).

### CROSS-REFERENCE TO RELATED APPLICATION

The instant application benefits from a priority provided under 35 U.S.C. §119(e), to U.S. Provisional Patent Application No. 60/442,128, filed Jan. 24, 2003.

### BACKGROUND OF INVENTION

1. Field of Invention

The present invention relates to commerce systems and methods, and more particularly, to an online commerce system and method for facilitating financial transactions via the Internet to be debited to a telecommunications account.

2. Description of Related Art

Online commerce allows for the buying and selling of goods and services over the Internet. The popularity of online commerce has grown tremendously in recent years as businesses (e.g., “brick-and-mortar” merchants, online retailers, and service providers) and customers have begun to recognize the potential and efficiencies of the online marketplace. Correspondingly, many businesses now utilize the Internet to advertise and sell both offline and online goods and services, and customers buy such items from the convenience of their personal computers, laptops, web-enabled handheld devices, public kiosks, etc.

One particular aspect of online commerce has exceptional potential: micropayments. A micropayment is generally referred to as a payment for a small-scale purchase, typically in an amount less than ten dollars (US), or even less than one cent. The use of micropayments is especially well suited for online commerce due to the low cost associated with many goods and services sold over the Internet. For example, micropayments can be charged to view a web page, to read an online newspaper article, to download a song in Moving Picture Experts Group (MPEG) Audio Layer-3 (MP3) format, or to use an online search engine. Another advantage of micropayments is that they require less security than conventional payments because the risk and loss associated with a compromised purchase is minimal.

The realization of the full potential of online commerce remains hampered by conventional payment systems and methods. In general, traditional online commerce payment models include conventional credit cards, digital cash, and digital wallets. In online credit card payment systems, customers send their credit card numbers to merchants through Internet connections. Typically, the merchant sends this information via a phone line to a credit card company or bank during every transaction. While the use of credit cards is the most popular form of online payment, such systems have at least the following drawbacks. For example, online credit card payment systems exclude the many people who do not have credit cards and are often burdensome by requiring customers to enter their personal information and credit card number each time they want to make a purchase. Moreover, online credit card payment systems are susceptible to fraud because unintended third parties may intercept the sensitive information, such as the account number of a credit card and the expiration date, which are sometimes sent over poorly secured phone lines and network connections. Due to transaction costs that outweigh small purchases in value, online credit card systems are unprofitable for merchants in the context of micropayments. For example, merchants using credit card payment systems incur high transaction costs because they must send forms to be processed manually by the credit card companies, thereby resulting in large overhead costs and time delays. Generally, merchants are required to pay processing fees to banks and credit card companies for each transaction. As a result, merchants using online credit card payment systems are not encouraged to allow customers to make micropayments or alternatively, require customers to purchase unwanted or bundled products to satisfy minimum buying requirements.

Current online payment methods that allow for micropayments include digital cash and digital wallets. Digital cash usually employs an encrypted serial number that operates to provide an electronic version of paper money and coins. In a digital cash payment system, a bank issues currency, customers deposit and withdraw currency from a bank account, and merchants accept this currency as payment for goods and services. In a digital currency payment model, cryptography must be used for security and authentication. Digital cash payment systems often impose inconveniences on customers before the may begin using the system. Often, the customer must provide proof of identity and a cancelled check if the digital cash is tied to a checking account. If the digital cash is tied to a credit card, the customer usually must create a positive balance before using the digital currency.

A digital wallet typically employs software to maintain and organize a customer's digital cash. Digital wallets require customers to deposit cash in order to create a balance and to download and install application software before they can begin making online payments. Many of these systems are also limited by the restriction that customers may only conduct online transactions from the one computer on which their wallet software is installed.

U.S. Patent Application Publication No. 2003/0200182 to Truitt et al. (“Truitt”), the disclosure of which is incorporated by reference herein in its entirety, describes a payment system with an option to select payment for the transaction from an account associated with a communication line, e.g., telephone, via which an electronic terminal is connected to a communication network. Although this system provides an additional payment alternative, it suffers from at least the following disadvantages. In order to facilitate payment using a telephone account, Truitt requires a transaction validation and processing module to facilitate validation for each transaction with the telephone or telecommunications company (TELCO). Therefore, Truitt is more like a facilitator for credit card online purchases, where for each transaction, credit card users have to reenter their credit card number and expiry date. Moreover, in a multiple TELCO environment, each TELCO is required to have one of these modules. Moreover, each customer has to enter information pertaining to their telephone account and identification for every transaction, which is cumbersome if a high number of transactions are being conducted in a short time. In addition, customers of this system are unable to roam, i.e., make purchases from any Internet connected terminal, since Truitt requires validation that the phone or communications line that the customer is employing during the transaction matches the phone line associated with the account. Therefore, Truitt customers are not permitted to make an online purchase and bill that purchase to their telephone account if they are using, for example, a public terminal.

The foregoing and other drawbacks of conventional payment systems have limited the goods and services available for online purchase and discouraged widespread consumer acceptance of online commerce.

### SUMMARY OF THE INVENTION

The present invention overcomes these and other deficiencies of the related art by providing an efficient and convenient payment system and method that allows businesses and consumers to conduct a secure payment, such as micropayment, transaction online. Particularly, the invention allows consumers to purchase items over the Internet or any other appropriate network via payments billed to a telephone account or the like in real time. The invention provides a secure online payment system that enables transactions as low as 0.01 of one cent, or lower if needed, per item.

In at least one embodiment of the invention, a method for facilitating online commerce is provided comprising the steps of: accessing or facilitating a web page displaying an item or service available for purchase; generating, transmitting, or receiving a request from a consumer to purchase the item or service; and facilitating the purchase to be charged to a telecommunications account, wherein the telecommunications account is not necessarily associated with a communications line by which the consumer has originated the request. The method can further comprises the step of authorizing the request to determine if the purchase is authorized, wherein the purchase is charged only if the purchase is authorized. The step of authorizing comprises the steps of: contacting a server servicing the telecommunications account, querying a subscriber database to determine if the consumer subscribes to a telephone account billing service, and generating a response comprising an indication of positive or negative authorization based on the query. The method can further comprise the step of determining whether an amount of the purchase is below a predetermined credit limit for the consumer. The value of the item or service is substantially equal to a micropayment amount. Moreover, a portion of a full amount of the purchase can be remitted to a merchant, wherein the portion is less than the full amount. The method further comprises the step of remitting an amount to a TELCO servicing the telecommunications account equal to a portion of a difference between the full amount and the portion remitted to the merchant. The step of facilitating comprises the step of communicating with a TELCO network via a SS7 communications protocol.

In at least one embodiment of the invention, a transaction system is provided comprising: a SS7 communication server, wherein the communications server comprises: a receiver for receiving information associated with a request to purchase an item or service offered online; and a processor to facilitate the purchase to be charged to a telecommunications account, and an authentication server for authenticating the telecommunications account. The authentication server preferably validates an amount of the purchase against a predefined credit limit.

In at least one embodiment of the invention, telephone account billing for purchases over the Internet is implemented by employing an authentication server and transaction server within a telecommunications company (TELCO) network. The authentication server facilitates, among other things, registration of TELCO customers for telephone account billing service and authorization of online purchases using the service. The transaction server comprises a communication bridge to join together consumers and merchants transacting business via an internet protocol network with one or more TELCO networks utilizing signaling system 7 (SS7) technology or the like. Accordingly, telephone account billing is integrated into merchant web sites, thereby providing consumers with a payment solution enabling “click and buy” purchases to be billed to a telephone account.

In at least one embodiment of the invention, a telephone customer registers for telephone account billing service directly with their TELCO via a registration web page. The registration web page comprises a form including a number of fields for the prospective subscriber to enter pertinent registration data. Registration data comprises an active telephone account, and a username (login identification) and password selected by the prospective subscriber. This registration data is forwarded to an authentication server, which validates the registration data against information stored in a TELCO customer database. If the prospective subscriber is an actual customer of the TELCO and the status of the entered telephone account is active and acceptable, a personal identification number (PIN) is generated. The prospective subscriber must then either call or be called by the TELCO using the phone number entered during registration. During that call, the prospective subscriber must enter the correct PIN, which was either previously sent via email or displayed via the registration web page. If the correct PIN is entered, the telephone customer is notified that the registration is successful and a completed registration record of this new subscriber is added to a subscriber database.

In at least one embodiment of the invention, an online purchase via a telephone account billing service is facilitated between a registered consumer, i.e., subscriber, and a merchant by appropriately configured computing equipment at each respective premises. To initiate the transaction, the consumer locates via a web browser a merchant's web page offering an item representing a good or service for purchase by telephone account billing. The consumer initiates the purchase by, for example, mouse clicking on an icon displayed on the merchant web page. Upon prompting, the consumer enters an assigned username, password, and information identifying their TELCO (and country and/or region if needed). The consumer is validated by comparing the consumer's supplied username and password to an expected username and password corresponding to that consumer. If the consumer is not a valid subscriber, then the purchase is not accepted. If the consumer is a valid subscriber, then the purchase itself is validated by, for example, checking a specified credit limit designated for that subscriber. If the purchase is deemed valid, the purchase is allowed by the merchant. Otherwise, the purchase is not accepted via telephone account billing. Upon allowing the purchase, information relating to the transaction is stored in a transaction database at the customer and merchant's TELCO. The purchase is then billed to the subscriber's telephone account and payment is credited to the merchant's telephone account or remitted to the merchant by a conventional technique such as a check.

An advantage of the invention is that it doesn't require an intermediate module to facilitate communication with TELCO databases. Hence, systems adopting the processes described herein are very fast and secure. Another advantage is that consumers are only required to logon into the system once first before they can purchase using telephone account billing. Particularly, once a consumer has successfully logged in, they can make multiple purchases either at the same merchant or different merchants during an active session. They do not need to login (or reenter account information) for each transaction. Moreover, consumers can purchase items and/or services from any computer located anywhere using the present invention. The present invention does not require purchase to be originated from a computer, which is accessing the Internet using the phone line (i.e., their telephone number) associated with the telecommunications account being billed.

An advantage of the invention is that businesses are provided with an efficient payment system for online transactions including micropayments. Another advantage is that the invention provides businesses with the opportunity to sell goods and services otherwise not feasible due to prohibited costs associated with conventional payment systems. Moreover, the invention enables consumers to purchase various offline and online goods and services in a non-intrusive manner without the disclosure of sensitive personal and financial information. Another advantage of the invention is that it provides an appropriate level of security for micropayments and enables merchants to reach a larger consumer base and to increase sales. Thus, the invention allows for the full potential of online commerce to be realized, thereby fostering widespread consumer acceptance.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates an online telephone account transaction system according to at least one embodiment of the invention;

FIG. 2 illustrates an online telephone account transaction method according to an embodiment of the invention;

FIG. 3 illustrates a telephone account billing system according to at least one embodiment of the invention;

FIG. 4 illustrates a payment authorization method according to at least one embodiment of the invention;

FIGS. 5A-B illustrate remittance systems according to two exemplary embodiments of the invention;

FIG. 6 illustrates a processing fee arrangement according to at least one embodiment of the invention; and

FIG. 7 illustrates a business incentive model according to at least one embodiment of the invention.

### DETAILED DESCRIPTION OF THE PREFERRED EMBODIMENTS

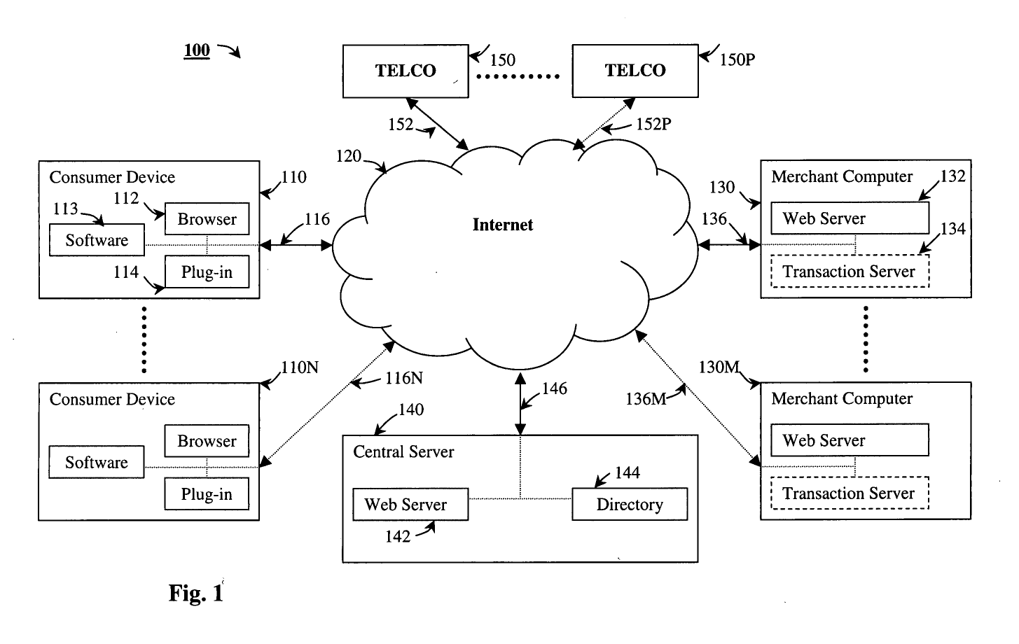

Preferred embodiments of the present invention and their advantages may be understood by referring to FIGS. 1-7, wherein like reference numerals refer to like elements, and are described in the context of online payments, particularly small electronic commerce (e-commerce) transactions, such as micropayments, implemented via the world wide web (the “web”) and billed to a consumer's telecommunications, e.g., telephone, cable television, or satellite, account. Nevertheless, the inventive concept can be practiced in any type of communications network interfaced with a telecommunications billing network. Particularly, electronic commerce transactions are facilitated between “online,” i.e., Internet connected, consumers and merchants. Consumer purchases are debited to a telephone account (the concept of which is herein referred to as “telephone account billing”) that is serviced by a TELCO, e.g., purchases appear on that consumer's periodic billing statements. These purchases can include any item that is available online such as, but not limited to music downloads, software, credit reports, gift items, literature, news services, search engine services, ad-free web pages, available over the Internet. Consumers pay for their purchases by making payment to their TELCO. There is no restriction on the amount for each online transaction that can be carried out, however micropayments are particularly well suited for telephone account billing. Although the following specification is described in the context of a telephone account, any type of telecommunications account can serve in the place of the telephone account. For example, rather than servicing a telephone account, the system and methods described herein can service a cable television account, satellite television account, etc.

To simplify the present disclosure, particular terms are presented throughout the description in an attempt to differentiate between the particular parties or entities involved. For example, the term “consumer” is generally directed toward one who purchases goods from a merchant, whereas the term “customer” is generally directed toward a TELCO customer, i.e., one who has an account serviced by a TELCO. Moreover, the term “subscriber” is generally referring to a telephone customer that implements or subscribes to the service of telephone account billing. Nevertheless, one of ordinary skill in the art recognizes that these three terms can be more broadly construed and used interchangeably. For example, one who purchases goods or services from a merchant and has those purchases billed to a telephone account can be referred to as a consumer, a customer, and/or a subscriber.

In order to implement telephone account billing, a consumer must be a customer of at least one TELCO and have an active telephone number and account provided by that TELCO. In an embodiment of the invention, consumers register with their TELCO before obtaining the ability to bill online purchases to their telephone account. For example, telephone account billing can be one of the many services offered by a TELCO, in which a TELCO customer may selectively subscribe. Existing TELCO customers can activate telephone account billing by registering for the service (“subscribing”) with their TELCO via, for example, a web site featuring a telephone account billing registration web page. New TELCO customers can sign up for the service at the time of registering for conventional phone service. As will be explained in further detail, registration is preferably automated, wherein the registration data collected through the registration web page using conventional acquisition techniques, the implementation of which is apparent to one of ordinary skill in the art, is passed to an authentication server connected to the TELCO's network. The authentication server checks an appropriate TELCO customer database to verify if the prospective subscriber is actually a customer of that TELCO and the corresponding telephone account is in good standing, i.e., the account satisfies predetermined requirements at the time of initiating the telephone account billing service. If positive verification results, the customer's registration information is added to a subscriber database after successful completion of further security steps, the implementation of which is described in further detail below. Upon acceptance as a subscriber, telephone account billing service is activated, thereby enabling the TELCO customer to bill purchases to a corresponding telephone account. In an alternative embodiment of the invention, registration information from a prospective subscriber may be collected via an automated telephone interface or at a TELCO premises upon the prospective subscriber appearing in-person.

Merchants register to have telephone account billing as a customer payment option by similarly subscribing with the merchant's TELCO. Alternatively, merchants can also sign up through a centralized server hosted by a host entity. For example, all merchants are signed up and “belong to” a host entity. If a TELCO recommends a merchant to the host entity, the host entity will register and authorize the merchant. A referral fee is optionally returned to the TELCO in exchange for the referral. However, the merchant profile and associated data can be maintained by the merchant's TELCO. Transactions are updated at the relevant merchant TELCO and merchants will access their TELCO to check their account. Although a merchant telephone account is not technically required for remittance of merchant sales, a merchant telephone account enables merchant sales to be conveniently credited directly to the merchant's telephone account. Alternatively, the TELCO tenders payment to the host entity, which then handles remittance to the merchant rather than the TELCO doing so directly. The host entity forwards the funds to the merchants after subtracting an optional commission.

Referring to FIG. 1, a transaction system 100 that facilitates online purchase of merchant items by subscribers and to have those purchased items billed, i.e., debited, to a telephone account is illustrated according to at least one embodiment of the invention. Particularly, system 100 comprises a number “N” of consumer devices 110N, a communications network 120, a number “M” of merchant computers 130M, a central server 140, and a number “P” of TELCO networks 150P. A consumer device 110 can be any type of computing device, such as a personal computer, a personal digital assistant (PDA), a cellular phone, laptop, computing terminal, cable box, set top box, workstation, or the like, which is preferably enabled to navigate the web. Consumer device 110 implements a web browser 112, a software application 113, a browser plug-in 114, and a transceiver (not shown) for transmitting and receiving data via a communications link 116 connected to communications network 120. Merchant computer 130 can be any type of conventional system or device that manages network resources, the identification and implementation of which is apparent to one of skill in the art, and comprises a web server 132, an optional transaction server 134, and a transceiver (not shown) for transmitting and receiving data via a communications link 136 connected to communications network 120. Optional transaction server 134 can be a stand-alone server or reside within merchant computer 130. Central server 140 comprises a web server 142, a directory 144, and a transceiver (not shown) for transmitting and receiving data via a communications link 146. Web server 142 enables customers and/or merchants to perform tasks, such as account management, viewing a demonstration of the system, viewing details of their transaction histories, obtaining online support, etc. In at least one embodiment of the invention, consumers 110 have to log into the server 140 prior to making any purchase. Directory 144 comprises authorization information pertaining to the consumers and/or the information necessary to facilitate links to all TELCOs, optionally sorted by country, that offer telephone account billing as a service.

Communications network 120 is preferably the Internet, but alternatively can be any type of communications network for facilitating electronic transactions, such as, but not limited to a cellular network, a wide area network (WAN), a local area network (LAN), an infrared network, a microwave network, an intranet, an optical network, a cable television network, a hybrid fiber coax (HFC) network, a satellite network, or any combination thereof. In a preferred embodiment of the invention, communications network 120 is a transmission control protocol and Internet protocol (TCP/IP) network.

A TELCO network 150 comprises a computer network, such as a TCP/IP based network, integrated with any type of telephone network, such as a public switched telephone network (PSTN), integrated services digital network (ISDN), fiber distributed data interface (FDDI) network, or a combination thereof preferably implementing a common channel signaling (CCS) based protocol, such as signaling system number 7 (SS7). TELCO network 150 further comprises a transceiver (not shown) connected to communications network 120 and/or via one or more communication links 152P. A communications bridge (not shown) is employed within TELCO network 150 to connect communications between the SS7 portion of the network and the TCP/IP portion of the network. For example, the communications bridge converts TCP/IP communications to SS7 protocol signals and vice versa, the implementation of which is apparent to one of ordinary skill in the art.

The use of the TELCOs' SS7 network enables a common interface between all TELCOS, allows direct access to the TELCOs' databases, and provides a high level of security as the once-off PIN collection call with customer via SS7 provides identification unique to each consumer. The use of SS7 eliminates the need for an intermediate module to facilitate communication with TELCO and/or host entity databases as is required with Truitt's system. Therefore, any system implementing the embodiments described herein are very fast and secure. The TELCOs' SS7 network can be implemented for customer registration, customer verification for purchasing, purchase charging, and clearing of amounts due between TELCO.

The above-referenced transceivers can be any type of suitable device, such as, but not limited to a modem, ethernet card, cable modem, or a combination thereof, the implementation of which is apparent to one of ordinary skill in the art, for transmitting and receiving data communications to and from communications network 120. Communication links 116, 136, 146, and 152 can be implemented by any type or number of appropriate communications media, the identification and implementation of which is also apparent to one of ordinary skill in the art.

In order for a consumer to access and communicate with merchant web server 132 or web server 142, web browser 112 is implemented at consumer device 110. For example, web browser 112 enables consumer device 110 to communicate with web servers 132 and 142 through a communications protocol, such as, but not limited to hypertext transfer protocol (HTTP), secure socket layer (SSL) protocol (commonly referred to as “HTTPS”), or secure HTTP (S-HTTP). In an embodiment of the invention, software application 113 executes on consumer device 110 to provide subscriber authentication information to merchant computer 130 authentication server 348 as will be described in further detail. Plug-in 114 enables the installation of software application 113 on consumer device 110 and initiates the execution of software application 113. The particular software embodiment described herein comprising three separate components is exemplary only. One of ordinary skill in the art recognizes that computer-executable code for implementing one or more of the steps and processes disclosed herein can take any form and be adapted to operate on any computer platform. For example, a single software application can perform the operations of browser 112, software 113, and browser plug-in 114.

Merchant web server 132 facilitates communications with web browser 112. Particularly, merchant web server 132 enables a number of consumers to interact with the merchant's web site and identify items to be optionally purchased via telephone account billing regardless of a particular consumer's type of web connection or location in the world. In an embodiment of the invention, web server 132 comprises server control software (not shown) featuring, for example, one or more application programming interfaces (APIs) that configure and enable web server 132 to accept telephone account billing as a payment solution. For example, an API facilitates communications to and from consumer device 110 as described herein. In an embodiment of the invention, merchant computer 130 receives and installs the server control software on an existing merchant server upon the merchant registering with a TELCO. Server control software is provided by either the merchant's TELCO or downloaded from central server 140.

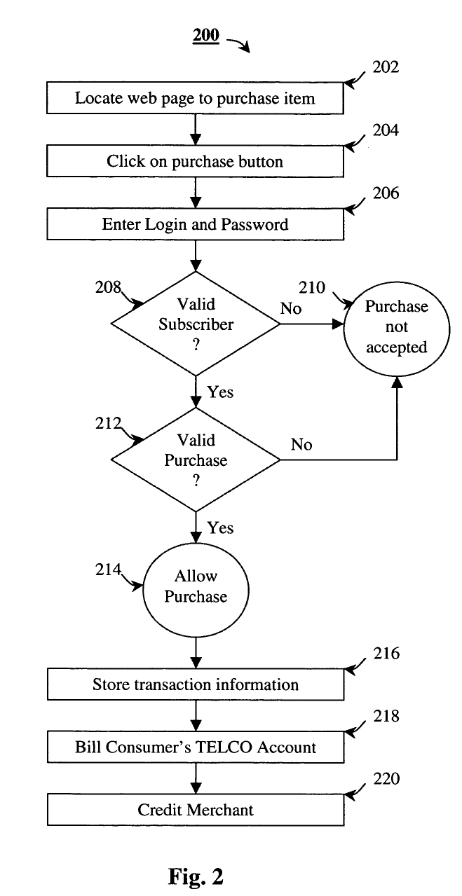

FIG. 2 illustrates a method 200 for transacting an online purchase using the telephone account billing service implemented by a registered consumer, i.e., subscriber, and a merchant with appropriately configured computing equipment as specified in transaction system 100. In operation, the consumer locates (step 202) via web browser 112 a merchant's web page hosted by web server 132, which offers an item representing a good or service and features telephone account billing as a payment option. The consumer initiates the purchase by, for example, mouse clicking (step 204) on an appropriate element or icon displayed on the web page. In response, the merchant's server control software directs plug-in 114 to initiate software 113 if not already executing.

Alternatively, associated with the icon are plug-in codes, which are on the merchant's HTML page (wherein the consumer has downloaded onto their computer and is now viewing). These plug-in codes check for the existence of the client control software 113 on the consumer device 110. If there is no client control software 113, the consumer is instructed to download the software. If the consumer has the control software 113, but is not logged in, the consumer is instructed to login with the user's identification and password, which are sent directly to the consumer's TELCO or central server 140 for validation. If the login is accepted, the merchant is notified either directly or indirectly (by the authorization associated with an active session). During the login and purchase process, the merchant server 130 preferably only contacts the consumer device 110 to notify the consumer of a successful purchase.

In yet another embodiment of the invention, a login/purchase process is implemented according to a “Passport” format. For example, a consumer browses a merchant web page and clicks on the telephone account buy-icon to purchase an item. The consumer is directed to a TELCO authentication webpage, which has been customized to reflect Merchant's look-and-feel, for login. The consumer logs in with the appropriate username and password. If the login is accepted, a session ID is activated. As long is this session ID is active any merchant will accept a purchase without requiring the consumer to reenter authorization or login information. The merchant is informed of the active status of the session upon query by the merchant. This status can be kept at the TELCO or the central server 140.

Upon prompting, the consumer enters (step 206) an assigned login identification or username, password, and optionally their TELCO and country if needed (these latter elements are provided as another layer of specificity as one TELCO might operate different networks in different countries. The consumer is validated (step 208) by comparing the consumer's supplied username and password to an expected username and password. Moreover, consumer validation can further include identifying whether the login identification is associated with an active telephone account in good standing. If the consumer is not a valid subscriber, then the purchase is not accepted (step 210). If the consumer is a valid subscriber, then the purchase itself is validated (step 212). A valid purchase is a purchase that is, for example, within a specified credit limit designated for that subscriber or further authorized as specified by the subscriber or the TELCO. If the purchase is deemed valid, the purchase is allowed (step 214) by the merchant server. Otherwise, the purchase is not accepted (step 210) via telephone account billing.

Upon allowing the purchase, information relating to the transaction is stored (step 216) at a transaction server 134 if present and within a transaction database at the respective merchant and consumer TELCOs. Such information can include information pertaining to the transaction, such as, but not limited to account information, for example, telephone number, subscriber identification, and identification of subscriber's TELCO; and transaction information, for example, purchase description, purchase price, merchant identification, date, and time. The purchase is billed (step 218) to the subscriber's telephone account and payment is credited (step 220) to the merchant's telephone account or remitted to the merchant by an alternative method, the identification and implementation of which is apparent to one of skill in the art. In an embodiment of the invention, a consumer only has to login once throughout each session, i.e., there is no need to enter a username and password again for any other telephone account billing purchases after initial login so long as the other purchases are valid or the session has not ended. For example, a session ends upon closing of software 113 or the predetermined expiration time of the session.

In at least one embodiment of the invention, the functions carried out by the transaction and authorization servers are conducted at the central server 140.

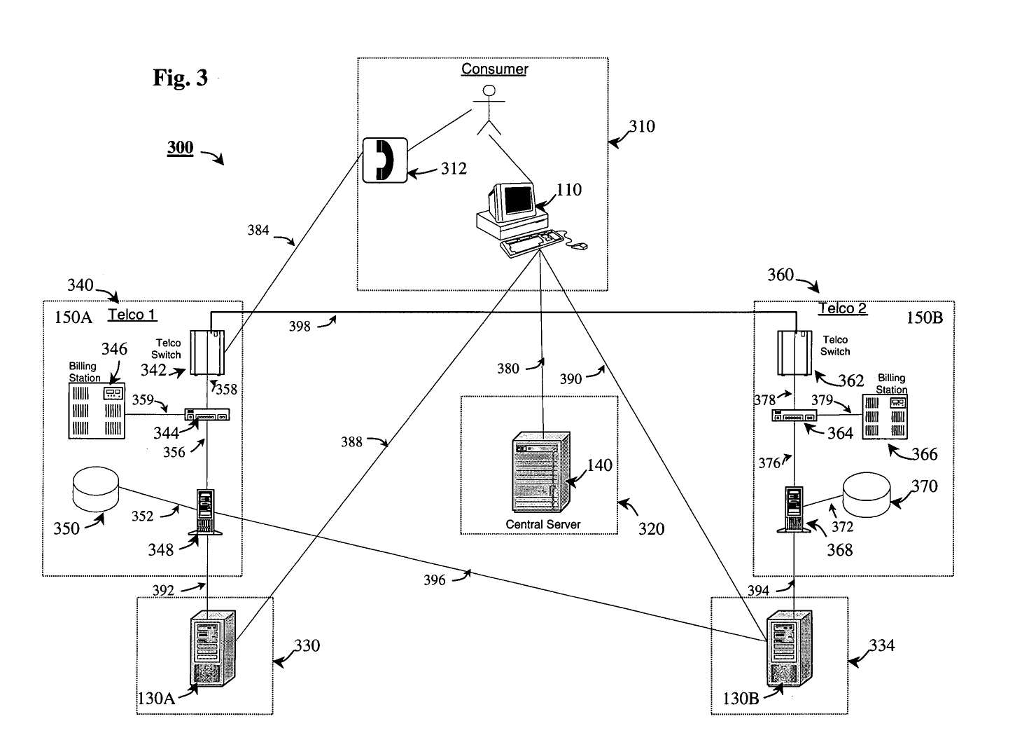

FIG. 3 illustrates a distributed telephone account billing system 300 featuring authentication and transaction servers located within a TELCO network according to an embodiment of the invention. The present embodiment depicts two merchants each associated with a respective TELCO and a single consumer in order to illustrate the consumer registration and transactions processes introduced above. Particularly, system 300 comprises a consumer entity (“consumer”) 310, a central serving or host entity 320, merchant entities (“merchants”) 330 and 334, and TELCO entities (“TELCO”) 340 and 360, which respectively comprise TELCO networks 150A and 150B. One of ordinary skill in the art recognizes that the term “entity” denotes that the respective parties can represent one or more individuals, a business, a network, an automated system, and the like or any combination thereof. Merchants 330 and 334 are each registered with respective TELCO entities 340 and 360. The number of consumer, merchant, and TELCO entities depicted is exemplary only and serves to simplify the discussion. In other words, system 300 can be adapted to support any number and combination of consumer, merchant, and TELCO entities. Typically, each entity is associated with a unique physical location or domain within a network. However, one of ordinary skill in the art recognizes that one or more of the entities may reside at the same physical location or within a single domain.

Consumer 310 comprises consumer device 110 and an active telephone account 312. In a characteristic arrangement, consumer device 110 is located at a residence or commercial premises being serviced or billed to by telephone account 312. Nevertheless, consumer device 110 can be a mobile device or remote computer allowing a consumer to access the web at a location distant from the residence or premises. Moreover, telephone account 312 can be a cellular telephone account as an alternative to a land-based telephone account. Central serving entity 320 comprises central server 140, which can communicate with consumer device 110 via link 380 comprising links 116 and 146 connected to communication network 120. Merchants 330 and 334 respectively comprise merchant servers 130A and 130B, which may be accessed via respective links 388 and 390 comprising links 116 and 136A or 136B connected to communication network 120.

TELCO network 150A comprises a telephone switch 342, a transaction server 344, a billing station 346, an authentication server 348, and a customer database 350. Similarly, TELCO network 150B comprises a telephone switch 362, a transaction server 364, a billing station 366, an authentication server 368, and a customer database 370. Conventional TELCO networks typically comprise components such as a number of TELCO switches, one or more billing stations and customer databases, the implementation of which is apparent to one of ordinary skill in the art. For example, conventional components such as TELCO switches 342 and 362 enable telephony communications, billing stations 346 and 366 enable the billing of such telephony communications to TELCO customers' accounts, and customer databases 350 and 370 comprise records of all the respective existing telecommunications customers. In order to facilitate telephone account billing, the invention couples transaction and authentication servers to a conventional telephone network. According to an embodiment of the invention, transaction servers 344 and 364, and authentication servers 348 and 368 are implemented on respective TELCO networks 150A and 150B. Transaction servers 344 and 364 facilitate the communications between respective TELCO switches 342 and 362, and billing stations 346 and 366 residing on a telephone network implementing, for example, SS7, and the outside computer network implementing for example, TCP/IP. Although only one transaction server and one authentication server are shown for each respective TELCO 340 or 360, multiple transaction and authentication servers can be implemented for load balancing.

Consumer 310 registers for telephone account billing service with TELCO 340 or host entity 320 via a registration web page. The registration web page can comprise a form including a number of fields for the prospective subscriber to enter pertinent registration data. Registration data can comprise a subscriber profile, which includes data, such as information pertaining to active telephone account 312 and a username (login) and password selected by the prospective subscriber. This registration data is forwarded to authentication server 348, which validates the registration data against information stored in customer database 350. In an embodiment of the invention, authentication server 348 queries customer database 350 via link 352 using a structured query language (SQL) or TCAP implemented through a standard database access method, such as an open database connectivity access method (ODBC). As discussed earlier, if the prospective subscriber consumer 310 is an actual customer of TELCO 340 and the status of telephone account 312 is active and in good standing, consumer's 310 registration is accepted and a subscriber database (not shown) located at either transaction server 344 or authentication server 348 is optionally updated to reflect the initial registration of consumer 310.

For security measures, additional steps are taken prior to the completion of the registration process. Particularly, to prevent fraud in identity during the registration process, authentication server 348 generates a personal identification number (PIN) for consumer 310 during registration to ensure that the person attempting to subscribe to the telephone account billing service is really the owner of the phone associated with telephone account 312. For example, consumer 310 must either call or be called by TELCO 340 or host entity 320 via phone 312. For example, transaction server 344 using a CCS based protocol, such as SS7, signals switch 342 via CCS link 358 to call the phone associated with telephone account 312 via phone line 384. During that call, consumer 310 is requested to enter the registration PIN, which was either previously sent via email or displayed via the registration web page. In an embodiment of the invention, consumer 310 may choose between calling the system themselves or having the system call them. If they choose the latter, then can specify a time when they can be reached at that phone number. Once the correct PIN is entered, the telephone customer is notified that registration is successful and a completed registration record of this new subscriber is added to the subscriber database.

Merchants 330 and 334 register with respective TELCO 340 and 360 to enable each merchant's computers 130A or 130B to accept telephone account billing as a payment option. Alternatively, merchants 330 and 334 register with central server 140. Upon registration, the web servers of merchant computers 130A and 130B are appropriately configured with server control software to accept telephone account billing as a payment solution. For example, during installation of the server control software, which is provided by either the TELCO or central server 140, a compound name or naming context is configured into the merchant computer. The compound name can be an IP address or location identifier based on a similar addressing scheme that specifies the location of the appropriate authentication server associated with the merchant's TELCO. For example, the compound name implemented in merchant computer 130A is addressed to authentication server 348.

Client control software (not shown) is installed in consumer device 110 upon registration of the consumer. Execution of this software can be initiated by either the consumer or merchant computers 130A and 130B either prior to or at the time of purchase. In a preferred embodiment of the invention, client control software comprises a collapsible control panel or window, which is independent of the web browser, to indicate the consumer's credit limit and total purchases during a transaction session. In an embodiment of the invention, a customer enters the appropriate login name, password, and optionally country and TELCO during initial execution of the client control software. The client control software forwards this information to an authentication server of the relevant TELCO, which is identified from the consumer's selection of the country and TELCO drop down lists displayed at the login page, which verifies the validity of the information. A verification result is then returned to consumer device 110 indicating whether the consumer is a valid registered user.

Consumer device 110 is employed by consumer 310 to navigate a merchant's web site. For example, consumer 310 browses an e-commerce web site hosted by either merchant computer 130A or 130B via respective HTTP communications links 388 or 390. Once consumer 310 identifies an item to be purchased on the merchant's web page via telephone account billing, consumer 310 elects to make the purchase by clicking an appropriate icon on the web page, thereby sending a purchase request to the merchant. Before accepting the purchase, the merchant contacts the appropriate TELCO or central server to authorize the purchase.

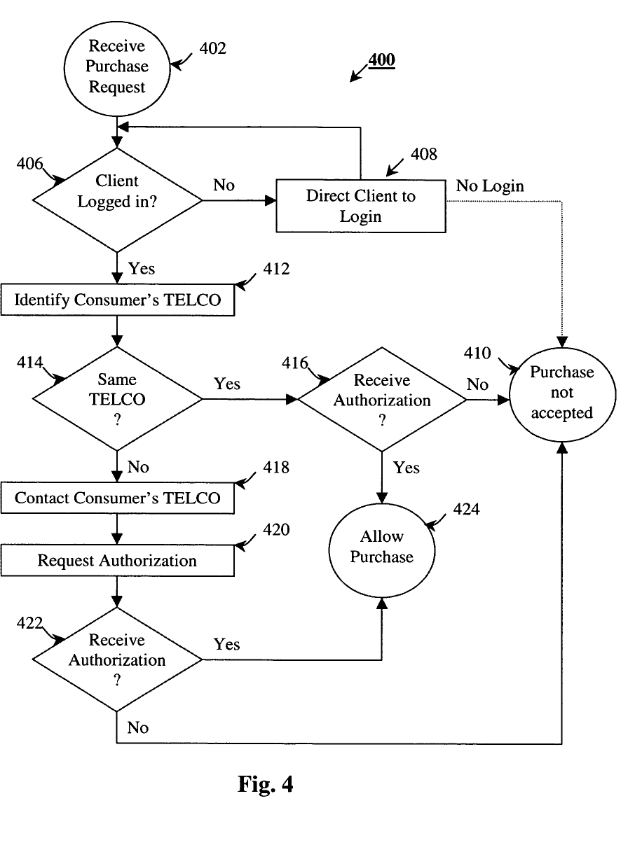

Referring to FIG. 4, a purchase authorization method 400 is implemented by a merchant server according to embodiment of the invention. Upon receiving a purchase request (step 402), the merchant server identifies (step 406) whether the consumer is logged in. If the consumer is not logged in, the merchant server directs the consumer's control software to request the consumer to login (step 408), wherein the consumer enters their username, password, and TELCO information. If the consumer can not successfully login, then the purchase is not accepted (step 410) via telephone account billing and the merchant, consumer, and/or appropriate TELCOs are optionally notified. Once the consumer successfully logs in, the merchant server then identifies (step 412) the consumer's TELCO provider and corresponding authentication server specified. The identity of consumer's TELCO is compared (step 414) to the identity of merchant's TELCO.

Consider an exemplary embodiment where consumer 310 and merchant 330 are serviced by the same TELCO, e.g., TELCO 340. Upon receipt of the purchase request via telephone account billing, merchant computer 130A requests an authorization of the purchase through TELCO entity 340. For example, merchant computer 130A contacts authorization server 348 via communications link 392 implementing, for example, a common object request broker architecture (COBRA). Authorization server 348 queries the subscriber database to validate the consumer and the purchase. Particularly, the consumer's account is checked to see whether the purchase is within a predefined credit limit of the consumer, the phone number is still valid, consumer's password is valid, the consumer is still qualified as a valid subscriber, or a combination thereof. Based on this determination, authorization server 348 notifies merchant computer 130A whether the purchase is authorized. If TELCO 340 authorizes the purchase (step 416), merchant computer 130A allows (step 424) the consumer to purchase the item. Merchant computer 130A then notifies authentication server 348 of the completed transaction. In turn, authentication server 348 signals transaction server 344 to record transaction information comprising consumer account 312 via TCP/IP link 356 and record transaction information comprising consumer information, merchant information, transaction number, amount, product description, date & time, or any combination thereof in a transaction database (not shown). This transaction information is forwarded to billing station 346 via SS7 or TCAP link 359. If authentication server 348 does not authorize the purchase, merchant computer 130A does not allow (step 410) the customer to purchase the item by telephone account billing.

Now consider an exemplary embodiment where consumer 310 attempts a purchase from merchant 334, which is serviced by TELCO entity 360. Similar to the first exemplary embodiment, consumer 310 employs consumer device 110 to connect to merchant computer 130B. Upon receipt of the purchase request, merchant computer 130B contacts (step 418) TELCO entity 340 to request (step 420) an authorization of the purchase from authentication server 348. However, this step can be implemented in one of two ways. In one embodiment, authorization server 348 is contacted directly by merchant computer 130B via TCP/IP link 396, which validates the purchase as mentioned above, and then notifies merchant computer 130B whether the purchase is authorized. In an alternative approach, merchant computer 130B contacts TELCO entity 340 via TELCO entity 360. For example, merchant computer 130B contacts authentication server 368 via a TCP/IP link 394. Authentication server 368 then directs transaction server 364 via CORBA link 376 to initiate communications with TELCO switch 362 via SS7 link 378. TELCO switch 362 contacts TELCO switch 342 via a communications link 398 operating between TELCO entities 340 and 360. In an embodiment of the invention, communications link 398 facilitates transaction capabilities application part (TCAP) protocol transmissions. TELCO switch 342 then forwards the authorization request to transaction server 344, which communicates with authorization server 348 to validate the purchase. Merchant computer 130B is then notified by reversing the path between TELCOs 340 and 360. If TELCO 340 authorizes the purchase (step 422), merchant computer 130B allows (step 424) the customer to purchase the item and notifies authentication servers 348 and/or 368, and transaction server 344 and/or 364 of the completed transaction. In turn, transaction server 344 bills customer account 312 via billing station 346 via SS7 or TCAP. Payment can be remitted to merchant 334 by communicating with transaction server 364, which directs billing station 366 via SS7 link 379 to credit merchant's account an appropriate amount. If authentication server 348 does not authorize the purchase, merchant computer 130B does not allow (step 410) the customer to purchase the item. In an embodiment of the invention, the purchase amount is added to the total purchases counter on the control panel. The purchased items are delivered to the customer by conventional means, the identification and implementation of which are apparent to one of skill in the art. For example, purchased content downloads to the customer's computer or the results of a purchased search are displayed by customer's web browser. Notwithstanding, purchases can include real goods that are shipped to the consumer.

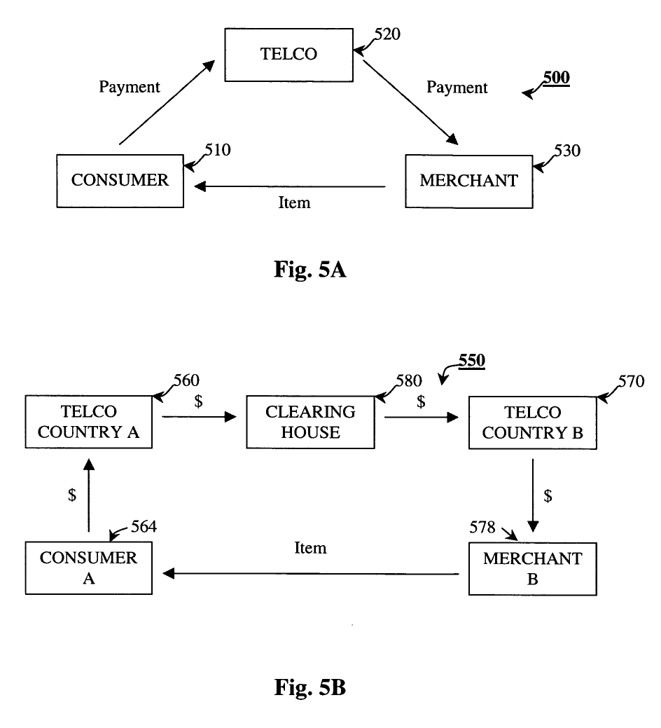

For authorized purchases, the merchant's TELCO provides remittance to the merchant. Alternative, the central entity 320 receives payment via the TELCOs and then pays the merchant, thereby alleviating the TELCOs of transaction issues, whether business or technical. Remittance can be provided to the merchant prior to or upon the TELCO receiving payment from the consumer. Referring to FIG. 5A, a remittance system 500 is illustrated according to an exemplary transaction embodiment where a consumer and merchant are registered with the same TELCO. Particularly, remittance system 500 comprises a consumer 510, a TELCO 520, and a merchant 530. In operation, consumer 510 purchases an online item from merchant 530. Customer makes payment to the TELCO 520 via a monthly telephone bill or the like. TELCO 520 remits payment to merchant 530. The net amount received by merchant 530 can be the same amount as the consumer's payment amount or a portion thereof. For example, TELCO 520 and a proprietary interest may keep a portion of the consumer's payment by charging a transaction fee, which is a percentage of the purchase.

FIG. 5B illustrates a remittance system 550 according to another exemplary transaction embodiment where a consumer and merchant are registered with separate TELCOs in different countries. Particularly, remittance system 550 comprises a TELCO 560 in country A and a consumer 565 registered therewith; a TELCO 570 in country B and a merchant 575 registered therewith; and a clearinghouse or host entity 580. In an example transaction, the flow of which is indicated by arrows in the figure, consumer 565 in country A purchases an online item form merchant 575 in country B in the currency of country B. TELCO 560 bills consumer 564 in country A's currency. In an embodiment of the invention, the exchange rate between country A and B is determined by clearinghouse 580 according to a standard exchange rate set on the day of purchase. Customer 565 makes payment to TELCO 560, which forwards a payment to clearinghouse 580. Clearinghouse 580 transfers a payment to merchant's TELCO 570, which remits a payment to merchant 575. In an embodiment of the invention, TELCOs 560 and 570, and clearinghouse 580 may each keep a percentage of the consumer's payment, thereby remitting a net amount to merchant 575 less than the full sales price. For example, if TELCOs 560 and 570 charge 2.5%, and clearinghouse 580 charges 5% of the purchased price, merchant 575 receives a net amount equal to 90% of the purchase price. In another embodiment of the invention, clearinghouse 580 is excluded from remittance system 550 and TELCOs 560 and 570 transfer funds directly to each other.

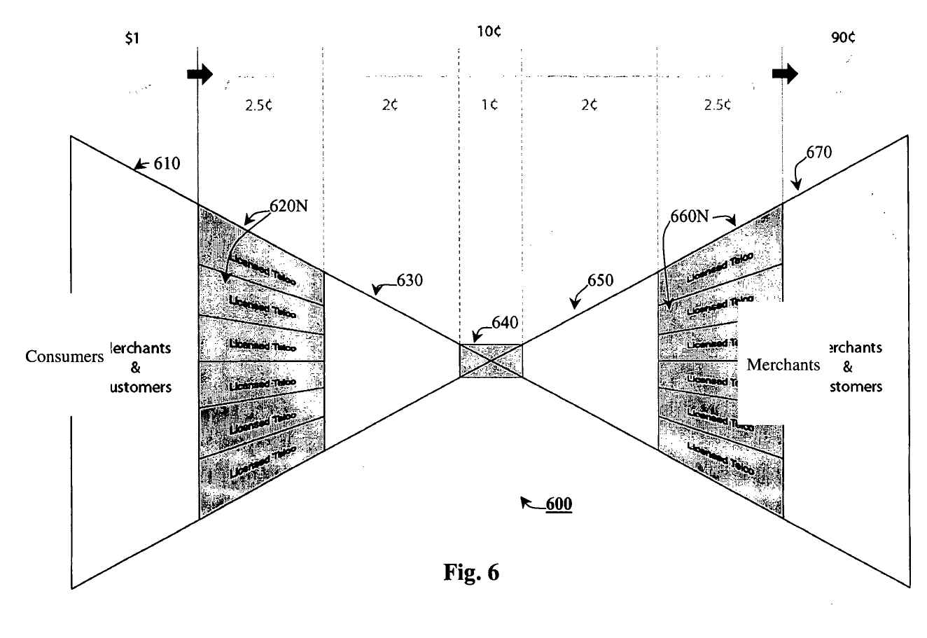

Referring to FIG. 6, a processing fee arrangement 600 is depicted to illustrate the incentives provided to TELCOs for implementing telephone account billing as a service offered to TELCO customers, e.g., merchants and consumers, according to an embodiment of the invention. As shown at the top of the figure, transactions occur between consumers 610 on one side and merchants 670 on the other side. Consumers 610 are registered with one of TELCOs 620N and merchants are registered with one of TELCOs 660N or alternatively, with a central entity 640. For every dollar spent by a consumer 610, a merchant 670 receives ninety (90) percent or ninety cents on every dollar. Ten (10) percent or ten cents on every dollar purchased is distributed to the parties processing the transaction and any proprietary or ownership interest. These percentages are exemplary only and can be modified as needed.

In an embodiment of the invention, central entity 640 sets the transaction rules/laws and owns a share in optional entities 630 and 650, which can be operating companies that function as regional divisions of entity 640 and are responsible for signing up and servicing TELCOS in their respective region, e.g., entity 630 could serve the Asian-Pacific region while entity 650 could serve the North American region.

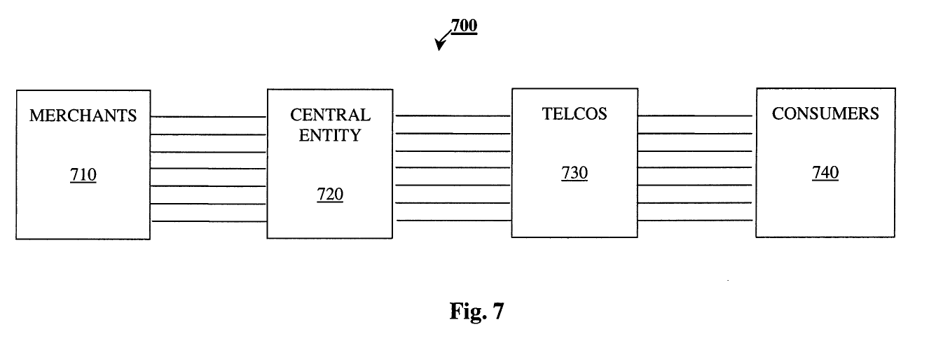

Referring to FIG. 7, a business incentive model 700 according to an embodiment of the invention is illustrated. In this embodiment, a central business entity 720 registers and services all TELCOs 730 in view of the system(s) and/or methods described above. Entity 720 also registers and hosts all merchants 710. TELCOs 730 sign up and host consumers 740. In a transaction, TELCO 730 collects payment from the a consumer 740 and passes this payment minus a commission to entity 720. Entity 720 is responsible for paying the merchant 710 (after taking out its own commission) even if the TELCO 730 has not paid yet, as the payment due from TELCO 730 can be considered an account receivable. If TELCO 730 wants to sign up a merchant 710, the TELCO 730 recommends merchant 730 to entity 720 who authorizes and hosts merchant 710. In an embodiment of the invention, TELCO 730 receives a commission on any sales using telephone account billing by merchant 710. The exact percentage of the commissions can be individually negotiated between the appropriate entities.

Consumers can make telephone account billing purchases via any device, which has Internet connection. Alternatively, they can also purchase via short messaging system (SMS). In at least one embodiment of the invention, a telephone account billing system employs a SMS-SS7 gateway. Under an SMS purchase, the consumer sends an SMS message to a merchant's SMS number. The SMS message comprises a username, password, item identification, and merchant identification. The SMS is delivered to the merchant's TELCO's SMS gateway. The SMS gateway routes the message to the customer authentication server using a transaction capabilities application part (TCAP) channel. The authentication server checks whether the consumer belongs to the same TELCO as the merchant. If the consumer belongs to the same TELCO as the merchant, the authentication server checks the database for the consumer's account status. If the consumer belongs to a different TELCO, the authentication server forwards the message to a transaction server, where it is converted to SS7 protocol and then routed to consumer's TELCO. The consumer's TELCO verifies the consumer's status and notifies the merchant's TELCO's authentication server. If the consumer's status is valid, i.e., the consumer meets predetermined criteria as specified earlier, the merchant's TELCO informs the merchant of the order and the merchant releases the product/service to the consumer. The merchant's authentication server sends a confirmation SMS message to the consumer.

Consumers implementing the present invention can bill purchases to a telephone account from any computer located anywhere. The consumer does not need to be accessing the Internet from a computer, which is using their registered phone line. In at least one embodiment of the invention, consumers can register just one before making a purchase because each consumer has his own unique username and password. Customer identification and transaction validation is tied to their telephone account validation by the appropriate entity and their account credit limit validation, not to the phone line they are using to connect to the Internet.

Telephone account billing for online purchases allows merchants to increase their consumer base and increase sales by allowing consumers to use a more convenient billing method for micropayments. For example, consumers without credit cards can purchase items on credit and those with credit cards can purchase items, which may not be feasibly purchased with credit cards. The inventive concept may be integrated into all e-commerce web sites and provides a billing service that is transparent to the consumer. In an embodiment of the invention, consumers may set up multiple accounts per phone number to allow, for example, family members to use the system with personal profiles for each member. However, only one member is designated as a primary user, thereby having the exclusive right to add secondary users and view transaction history and records of all users under that phone account.

Although the invention has been particularly shown and described with reference to several preferred embodiments thereof, it will be understood by those skilled in the art that various changes in form and details may be made therein without departing from the spirit and scope of the invention as defined in the appended claims.

We claim:

1. A method for facilitating online commerce comprising the steps of:
accessing or facilitating a web page displaying an item or service available for purchase;
generating, transmitting, or receiving a request from a consumer to purchase said item or service; and
facilitating said purchase to be charged to a telecommunications account,
wherein said telecommunications account is not necessarily associated with a communications line by which said consumer has originated said request.

2. The method of claim 1 further comprising the step of
authorizing said request to determine if said purchase is authorized, wherein said purchase is charged only if said purchase is authorized.

3. The method of claim 2, wherein said step of authorizing comprises the steps of:
contacting a server servicing said telecommunications account,
querying a subscriber database to determine if said consumer subscribes to a telephone account billing service, and
generating a response comprising an indication of positive or negative authorization based on said query.

4. The method of claim 3, further comprising the step of
determining whether an amount of said purchase is below a predetermined credit limit for said consumer.

5. The method of claim 1, wherein a value of said item or service is substantially equal to a micropayment amount.

6. The method of claim 1, further comprising the step of
remitting a portion of a full amount of said purchase to a merchant, wherein said portion is less than said full amount.

7. The method of claim 6, further comprising the step of
remitting an amount to a TELCO servicing said telecommunications account equal to a portion of a difference between said full amount and said portion remitted to said merchant.

8. The method of claim 1, wherein said step of facilitating comprises the step of:
communicating with a TELCO network via a SS7 communications protocol.

9. At least one signal embodied in at least one carrier wave for transmitting a computer program of instructions configured to be readable by at least one processor for instructing the at least one processor to execute a computer process for performing the method as recited in claim 1.

10. At least one processor readable carrier for storing a computer program of instructions configured to be readable by at least one processor for instructing the at least one processor to execute a computer process for performing the method as recited in claim 1.

11. A transaction system comprising:
a SS7 communication server, wherein said communications server comprises:
a receiver for receiving information associated with a request to purchase an item or service offered online; and
a processor to facilitate said purchase to be charged to a telecommunications account, and
an authentication server for authenticating said telecommunications account.

12. The transaction system of claim 11, wherein said authentication server validates an amount of the purchase against a predefined credit limit.

13. The transaction system of claim 11, wherein said SS7 communications server receives said request via a transmission control protocol and Internet protocol communications protocol.

14. The transaction system of claim 11, wherein said SS7 communications server is connected to a telephone network.

15. A method comprising the steps of:
activating a session to facilitate purchasing of items and/or services offered via a public communications network; and
facilitating at least one purchase to be charged to a telecommunications account during said session.
